(19) United States
(12) Patent Application Publication
(10) Pub. No.: US 2011/0255436 A1
(43) Pub. Date: Oct. 20, 2011

(54) Method of Optimizing Comp Zone for Joint Processing Mode

(76) Inventors: Xu Jian, Gyeonggi-do (KR); Ja Ho Koo, Gyeonggi-do (KR); Bin Chul Ihm, Gyeonggi-do (KR); Wook Bong Lee, Gyeonggi-do (KR)

(21) Appl. No.: 13/141,211

(22) PCT Filed: Jan. 4, 2010
(86) PCT No.: PCT/KR2010/000008

§ 371 Date: Jun. 21, 2011

Related U.S. Application Data
(60) Provisional application No. 61/224,477, filed on Jul. 10, 2009.

(51) Int. Cl. H04L 12/26; H04W 4/00

(52) U.S. Cl. 370/252; 370/329

(57) ABSTRACT

A method of optimizing a CoMP Zone for a joint processing mode is disclosed. A method of optimizing a CoMP zone for a joint processing mode in a user equipment of a mobile communication system comprises transmitting information of at least one subband preferred by the user equipment among a plurality of subbands included in the CoMP zone, to a serving base station; receiving information of a specific subband included in the CoMP zone from the serving base station; and receiving data from at least one of the serving base station and neighboring base stations that support the CoMP, through a radio resource corresponding to the specific subband.

### TECHNICAL FIELD

The present invention relates to a broadband wireless mobile communication system, and more particularly, to a method for optimizing a Coordinated Multi-Point (CoMP) zone for joint processing mode of CoMP.

### BACKGROUND ART

As an example of a mobile communication system to which the present invention can be applied, a third generation partnership project long term evolution (3GPP LTE) communication system will be described in brief.

FIG. 1 is a diagram illustrating a network structure of an E-UMTS (Evolved-Universal Mobile Telecommunications System) which is a mobile communication system. An E-UMTS is a system evolving from the conventional universal mobile telecommunication system (UMTS) and its basic standardization is currently handled by the 3GPP. Generally, The E-UMTS may be called a long term evolution (LTE) system.

The E-UMTS network may largely be classified into a UMTS terrestrial radio access network (E-UTRAN) 101 and a core network (CN) 102. The E-UTRAN 101 includes a user equipment (UE) 103, a base station (eNode-B or eNB) 104, and an access gateway (AG) which is located at an end of the network and is connected to an external network. The AG 105 may be classified into a part for handling user traffic and a part for handling control traffic. At this time, an AG for handling new user traffic may communicate with another AG for handling control traffic via a new interface.

At least one cell exists in one eNB. An interface for transmitting user traffic or control traffic may be located between eNBs. The core network (CN) 102 can include a node for user registration of other user equipment (UE) 103 and the access gateway 105. An interface for discriminating between the E-UTRAN 101 and the CN 102 may also be used.

Layers of a radio interface protocol between a UE and a network can be classified into a first layer L1, a second layer L2 and a third layer L3 based on three lower layers of an OSI (open system interconnection) standard model widely known in communication systems. A physical layer belonging to the first layer L1 provides an information transfer service using a physical channel. A radio resource control (hereinafter, abbreviated as ‘RRC’) layer located at the third layer plays a role in controlling radio resources between the UE and the network. For this, the RRC layer enables RRC messages to be exchanged between the UE and the network. The RRC layer may distributively be located at network nodes including the eNode B 104, the AG 105 and the like, or may independently be located at either the eNode B 104 or the AG 105.

FIG. 2 is an illustrating diagram of CoMP system including the intra eNB and inter eNB.

Referring to FIG. 2, intra eNB 110,120 and inter eNB 130 is present in multi-cell environment. Intra eNB 110,120 is including in a plurality of cells (or sectors) in LTE (Long Term Evolution) system. The cells of eNB which serving specific UE correspond to intra eNB relation for the specific UE. In other words, the cells sharing with the same eNB are the cells of intra eNB 210, 220.

Cells of intra eNB 210,220 or inter eNB 230 can transmitting and receiving inter-cell information (for example, data, Channel State Information) through x2 interface or backhaul 260. As shown in FIG. 2, Single cell MIMO users 240 in a signal cell can communicating a serving eNB in a cell (sector), cell-boundary multi-cell MIMO users 250 can communicating multiple serving eNB in a multi-cell (sector).

Coordinated Multi-Point (CoMP) system can improve the throughput of at cell-boundary users using the improved MIMO transmission in multi-cell environment. In case of applying CoMP system, inter-cell interference can be reduced in multi-cell environment. UE can also simultaneously receive a data from multi-cell base-station using CoMP system.

In addition, each eNB can improve the performance of the system by supporting one or the more UEs using the same radio frequency. Furthermore, eNB can perform the SDMA (Space Division Multiple Access) method based on channel state information between UE and eNB.

CoMP scheme includes joint processing scheme of cooperative MIMO through data sharing and coordinated scheduling scheme/beamforming scheme.

Serving eNB and one or more cooperative eNBs can be connected to scheduler through the backhaul 160 or x2 interface. Scheduler can receive channel state information which is measured by each eNB through the backhaul 160. For example, co-operative MIMO operation is scheduled by scheduler for serving eNB and one or more cooperative eNBs. That is, scheduler can directly command for cooperative MIMO operation to each eNB.

From a theoretical point of view, if optimal transmission scheme is employed at the coordinated eNBs, which in general requires simultaneous transmission from eNBs to all UEs (i.e., CoMP-MU-MIMO operation mode), then there is throughput gain in serving both cell-center and cell-edge UEs under CoMP transmission. However, if the coordinated eNBs only serve one UE at any given time (i.e., CoMP-SU-MIMO operation mode), then there can be throughput loss in serving cell-center UEs under CoMP as discussed before. In order to perform different operations for cell-center UEs and the cell-edge UEs, several methods can be considered. One simple way is to create a CoMP zone where all the cell-edge UEs belonging to a CoMP cluster are jointly scheduled using CoMP-SU-MIMO mode while the cell-center UEs are scheduled by the individual cell.

FIG. 3 illustrates an exemplary cluster structure for CoMP Zone.

Referring to FIG. 3, a cell-edge UE is served by three cells by using a specific resource region. The resource region configured with specific subframes and subbands may be referred to as a CoMP Zone.

In this case, an efficient CoMP Zone allocation method is required to perform joint processing CoMP operation having more excellent throughput.

### DISCLOSURE OF INVENTION

### Technical Problem

An object of the present invention is to provide a method for optimizing a CoMP zone for joint processing mode of CoMP to improve throughput of cell edge users in a multi-cell environment.

Another object of the present invention is to provide a method for optimizing power allocation in the frequency domain and in the base station domain.

It is to be understood that technical problems to be solved by the present invention are not limited to the aforementioned technical problems and other technical problems which are not mentioned will be apparent from the following description to the person with an ordinary skill in the art to which the present invention pertains.

### Technical Solution

To solve the aforementioned technical problems, according to one embodiment of the present invention, a method of optimizing a CoMP Zone for a joint processing mode in a user equipment of a mobile communication system comprises transmitting information of at least one subband preferred by the user equipment among a plurality of subbands included in the CoMP zone, to a serving base station; receiving information of a specific subband included in the CoMP zone from the serving base station; and receiving data from at least one of the serving base station and neighboring base stations that support the CoMP, through a radio resource corresponding to the specific subband.

In this case, the method further comprises measuring channel quality information (CQI) of the serving base station; and determining whether the measured channel quality information has a value less than a previously set threshold value, wherein the step of transmitting the preferred subband information is performed if the value of the measured channel quality information is less than the previously set threshold value.

Also, the user equipment selects the at least one subband preferred by the user equipment by using the measured channel quality information.

Also, the specific subband is determined through agreement of the serving base station and the neighboring base stations.

Moreover, the method further comprises determining a power level of the serving base station through a reference signal; and performing channel measurement of the serving base station using the determined power level.

To solve the aforementioned technical problems, according to one embodiment of the present invention, a method of optimizing a CoMP Zone for a joint processing mode in a base station of a mobile communication system comprises receiving information of at least one subband preferred by the user equipment among a plurality of subbands included in the CoMP zone, from the user equipment; sharing user equipment information of a CoMP mode with at least one neighboring base station that supports the CoMP zone; performing selection and scheduling of a specific subband to be allocated to the user equipment using the user equipment information of the CoMP mode; transmitting information of the specific subband to the user equipment; and transmitting data to the user equipment through the specific subband.

In this case, the user equipment information of the CoMP mode includes at least one of the at least one subband information preferred by the user equipment, information of at least one another user equipment that receives the data through the CoMP zone, and at least one subband information preferred by at least one user equipment that desires to receive the data through the CoMP zone.

In this case, the user equipment information of the CoMP mode further includes power allocation information of a plurality of subbands included in the CoMP zone, the method further comprising deciding an optimized power level in a frequency domain together with the neighboring base stations.

Also, the method further comprises deciding an optimized power level in a base station domain together with the neighboring base stations.

Also, if long-term channel information is provided to the base station, the step of deciding the optimized power level in each domain depends on a water filling algorithm.

Moreover, if long-term channel information is not provided to the base station, the step of deciding the optimized power level in each domain is performed in accordance with a method of equally dividing the power level of each domain.

To solve the aforementioned technical problems, according to one embodiment of the present invention, a user equipment that supports a joint processing mode for CoMP comprises a processor; and a radio frequency (RF) module for transmitting and receiving a radio signal to and from the outside under the control of the processor; wherein the processor transmits information of at least one subband preferred by the user equipment among a plurality of subbands included in a CoMP zone, to a serving base station by controlling the RF module, and if information of a specific subband included in the CoMP zone is received from a serving base station, receives data from at least one among the serving base station and neighboring base stations that support the CoMP zone, through a radio resource corresponding to the specific subband.

In this case, the processor measures channel quality information (CQI) of the serving base station by controlling the RF module and transmitting the information of the preferred subband to the serving base station if a value of the measured channel quality information is less than a previously set threshold value.

Also, the processor selects the at least one preferred subband by using the measured channel quality information.

Also, the specific subband is determined through agreement of the serving base station and the neighboring base stations.

Moreover, the processor determines a power level of the serving base station through a reference signal, and performs channel measurement of the serving base station using the determined power level.

### Advantageous Effects

According to the embodiments of the present invention, the following advantages can be obtained.

First, throughput of cell-edge UEs can be improved by optimizing CoMP Zone.

Second, power level can be optimized in both the frequency domain and the eNB domain.

It is to be understood that the advantages that can be obtained by the present invention are not limited to the aforementioned advantages and other advantages which are not mentioned will be apparent from the following description to the person with an ordinary skill in the art to which the present invention pertains.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a network structure of an E-UMTS (Evolved-Universal Mobile Telecommunications System) which is a mobile communication system;

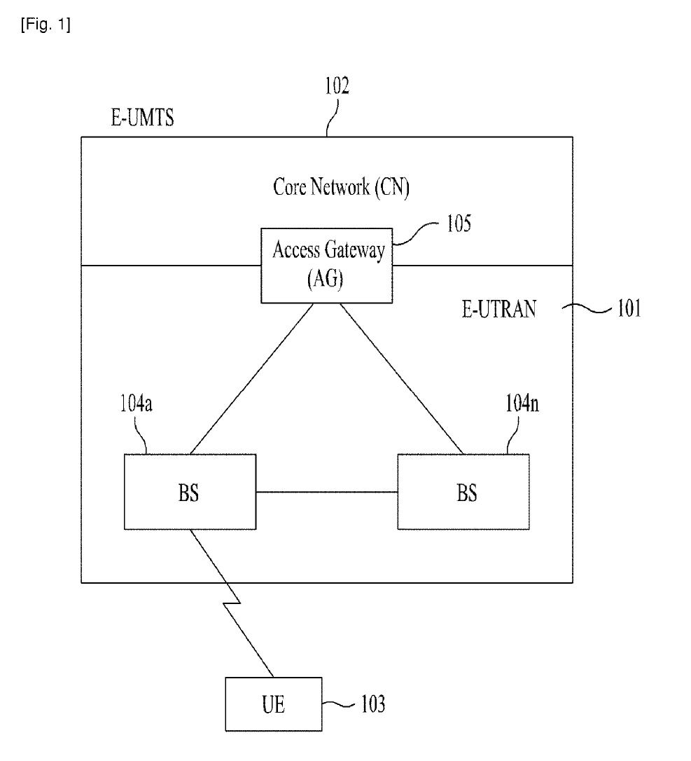

FIG. 2 is an illustrating diagram of CoMP system including the intra eNB and inter eNB;

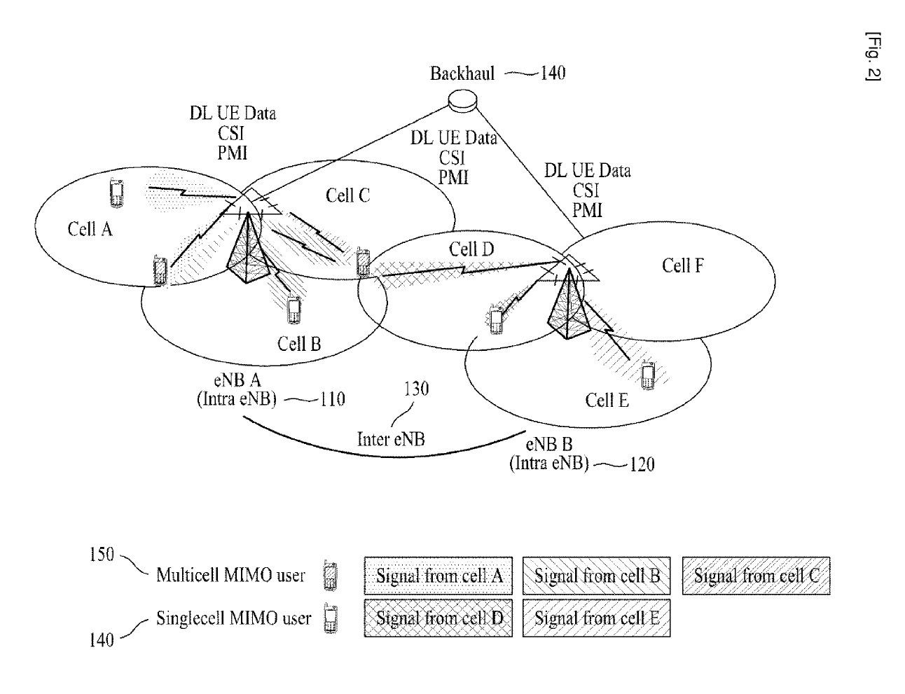

FIG. 3 illustrates an exemplary cluster structure for CoMP Zone;

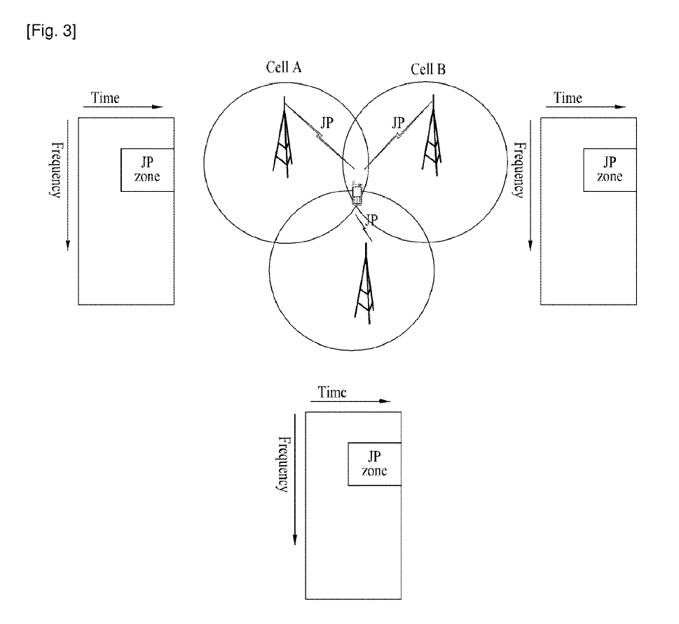

FIG. 4 is a diagram illustrating an example of a frequency allocation type in a CoMP Zone in accordance with one embodiment of the present invention;

FIG. 5 is a diagram illustrating a method of performing a CoMP operation in a user equipment according to one embodiment of the present invention;

FIG. 6 is a diagram illustrating a method of performing a CoMP operation in a plurality of user equipments and a base station according to one embodiment of the present invention;

FIG. 7 is a diagram illustrating an example of subband allocation according to one embodiment of the present invention;

FIG. 8 is a diagram illustrating an example of subband and power allocation through a water filling algorithm in a frequency domain and a base station domain according to one embodiment of the present invention; and

FIG. 9 is a block diagram illustrating an example of a structure of a transmitting side and a receiving side according to another embodiment of the present invention.

### MODE FOR THE INVENTION

Reference will now be made in detail to the preferred embodiments of the present invention, examples of which are illustrated in the accompanying drawings. Wherever possible, the same reference numbers will be used throughout the drawings to refer to the same or like parts. In the following detailed description of the invention includes details to help the full understanding of the present invention. Yet, it is apparent to those skilled in the art that the present invention can be implemented without these details. ((For instance, although the following detailed description is made in detail on the assumption that a mobile communication system is the 3GPP LTE system, it is applicable to other prescribed mobile communication systems by excluding unique items of the 3GPP LTE.))

Occasionally, the structures and devices known to the public are omitted to avoid conceptional vagueness of the present invention or can be illustrated as block diagrams centering on their core functions.

Besides, in the following description, assume that a terminal is a generic term of such a mobile or fixed user-end device as a user equipment (UE), a mobile station (MS) and the like. Moreover, assume that a base station is a generic name of such a random node of a network end, which communicates with a terminal, as a Node B, an eNode B and the like.

Hereinafter, an optimization scheme of a CoMP zone based LTE-A joint processing mode according to the present invention will be described.

The optimization scheme according to the present invention will be described based on a method of using a predetermined CoMP zone divided in a unit of subband in a frequency domain. However, the present invention is not limited to the above method and may also be applied to a method of dividing a CoMP zone in a unit of subframe in a time domain.

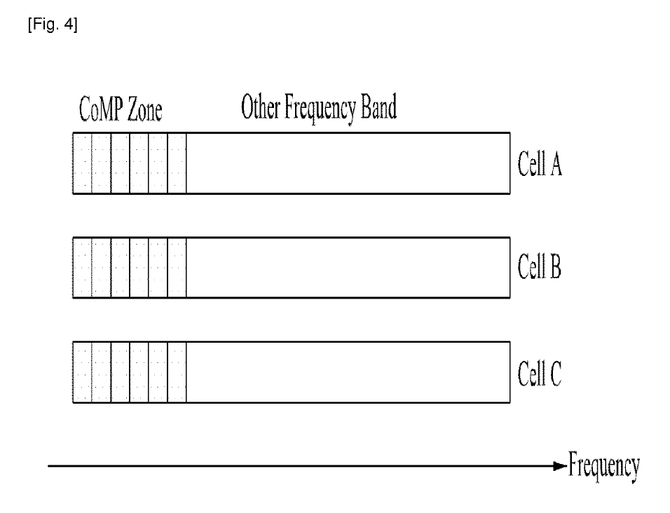

FIG. 4 is a diagram illustrating an example of a frequency allocation type in a CoMP Zone in accordance with one embodiment of the present invention.

Referring to FIG. 4, resource regions of three neighboring cells are arranged on a frequency axis. In this case, among the resource regions of the respective cells, some region corresponding to a specific frequency band may be set as a CoMP zone for a cell-edge user equipment (UE). At this time, the resource regions corresponding to the CoMP zone can be divided into predetermined subbands.

In the embodiment of the present invention, it is assumed that information of the CoMP zone and subbands included in the CoMP zone is previously shared by the user equipment and the base station.

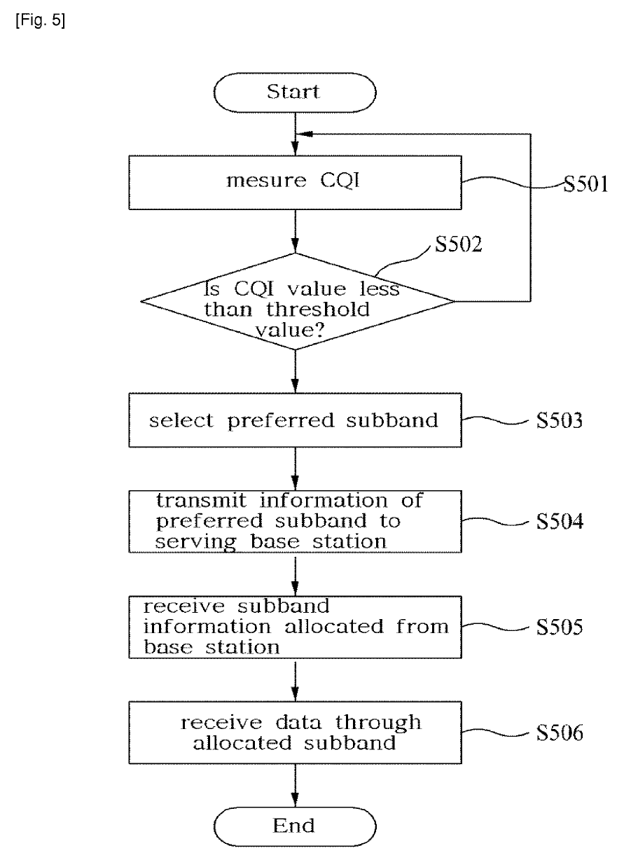

According to one embodiment of the present invention, there is provided a method of reporting information of a subband included in a CoMP zone and preferred by a user equipment to a base station and allocating a subband, which will transmit data, from the base station to the user equipment with reference to the information of the subband. This method will be described with reference to FIG. 5.

FIG. 5 is a diagram illustrating a method of performing a CoMP operation in a user equipment according to one embodiment of the present invention.

First of all, the user equipment measures channel quality information (CQI) of a serving cell (S501).

The user equipment decides whether to receive data through a CoMP operation, using the measured CQI value (S502). In other words, if the user equipment is located in a cell boundary region, strength of a signal received from the serving cell becomes weak, whereby quality of the measured CQI value is deteriorated. If the measured CQI value reaches a threshold value which is previously set, the user equipment can request the base station to receive data through the CoMP zone for better data transmission and reception. At this time, the number of cell-edge UEs and the number of neighboring cells may depend on the previously set threshold value.

The user equipment selects at least one preferred subband among subbands included in the CoMP zone using the current channel information or the measured CQI value (S503).

The user equipment transmits information of the preferred subband to its serving cell (S504).

Then, the serving base station performs information exchange for subband selection of a CoMP zone, which is scheduled to transmit data to the corresponding user equipment and the base station of neighboring cell, and scheduling according to the information exchange, with reference to the preferred subband information received from the user equipment. At this time, the exchanged information includes preferred subband information of the user equipment, preferred subband information of other user equipment, which is received by other base station, and scheduling information of the user equipment that receives data through the current CoMP zone.

As a result of the information exchange procedure, a specific subband of the CoMP zone is allocated to a subband where data transmission of a joint processing CoMP mode for the corresponding user equipment is performed, and information of the allocated subband is transmitted to the user equipment (S505).

Afterwards, the user equipment receives data through the specific subband selected in the step 5505 in the CoMP zone of neighboring cells (S506).

In this case, in the case that the base station selects a subband for the user equipment that requests data transmission using the CoMP zone and performs scheduling, it is preferable that the following details should be considered:
1) in order to ensure equity between the user equipments that request data transmission using the joint processing CoMP zone, the number of user equipments operated in a CoMP mode and the number of available subbands should be considered;
2) if the number of user equipments that are operated in the CoMP mode or want the operation is greater than the number of subbands of the available CoMP zones, a plurality of user equipments should share one subband. Accordingly, it is preferable that the number of user equipments that use one subband is limited to a proper number or less;
3) when considering signaling overhead, it is preferable that a small number of subbands are included in the CoMP zone if possible; and
4) since information of the subband allocated to the user equipment should obtain agreement of all neighboring base stations, the base stations should together share information of subbands selected by themselves prior to final decision and allocation of the subbands.

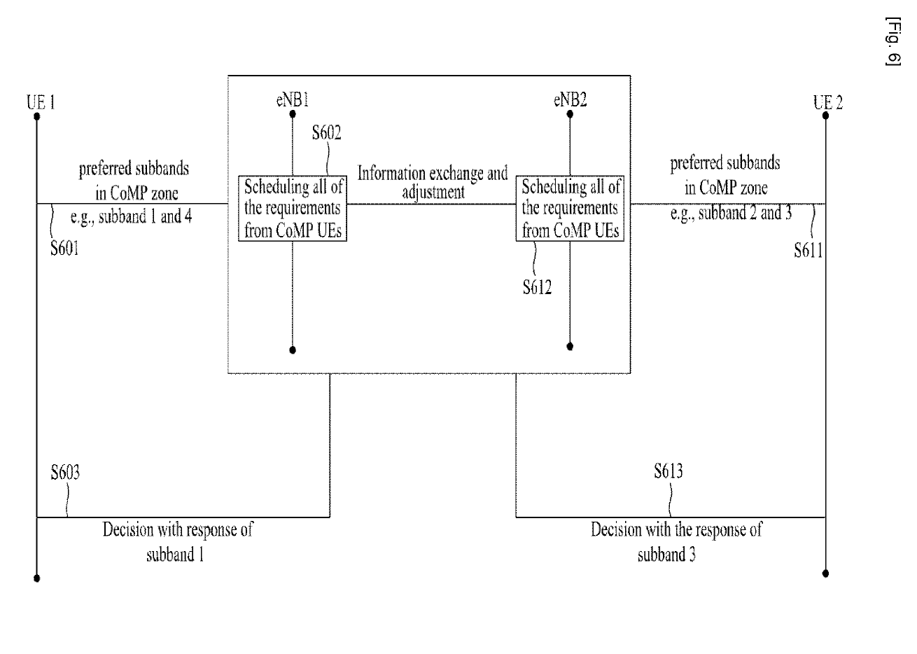

FIG. 6 is a diagram illustrating a method of performing a CoMP operation in a plurality of user equipments and a base station according to one embodiment of the present invention.

Although FIG. 5 illustrates the CoMP operation based on the operation of one user equipment, FIG. 6 illustrates operations of two user equipments located in edges of two neighboring cells.

Referring to FIG. 6, the two user equipments transmit their preferred subband information (in this case, user equipment 1 prefers subbands 1 and 4 while user equipment 2 prefers subbands 2 and 3) to their serving base stations to request the base stations to perform a joint processing CoMP mode operation if the previously set condition is satisfied (S601 and S611).

Then, each serving base station shares the preferred subband information considering requirements of the user equipments and decides subbands to be allocated to the respective user equipments based on the shared subband information (S602 and S612).

Each serving base station allocates the decided subbands to the corresponding user equipments (in this case, subband 1 to user equipment 1 and subband 3 to user equipment 2) (S603 and S613).

Afterwards, each base station transmits data for user equipment 1 through the subband 1, and transmits data for user equipment 2 through the subband 3 in accordance with the joint processing CoMP mode.

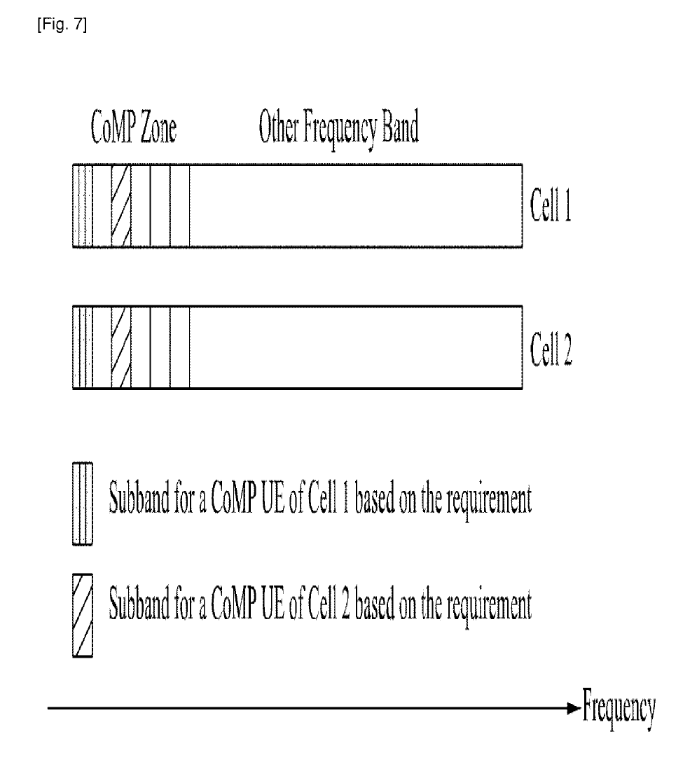

FIG. 7 is a diagram illustrating an example of subband allocation according to one embodiment of the present invention.

FIG. 7 illustrates the result of the subband allocation performed in FIG. 6 on the frequency axis. Referring to FIG. 7, it is noted that the subbands 1 and 3 are allocated from the two base stations, wherein the subband 1 is for user equipment 1 and the subband 3 is for user equipment 2.

Hereinafter, power allocation that can be applied to the joint processing CoMP mode according to the present invention will be described.

Preferably, the power allocation is performed between the base stations as well as the subbands. In other words, it is preferable that the power allocation is performed between neighboring base stations that join the CoMP operation, as well as in the frequency domain. This is because that all base stations that join the CoMP operation transmit same data to the user equipment, which is operated in the CoMP mode, through a specific subband.

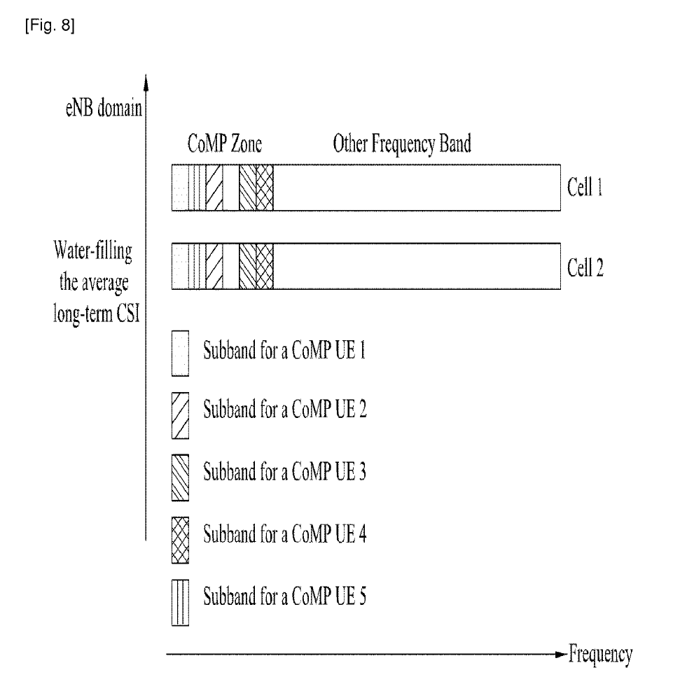

If long-term channel state information (CSI) is available in the base station, a water filling algorithm can be applied to a frequency domain and a base station domain based on average channel status information. This will be described with reference to FIG. 8.

FIG. 8 is a diagram illustrating an example of subband and power allocation through a water filling algorithm in a frequency domain and a base station (eNB) domain according to one embodiment of the present invention.

Referring to FIG. 8, a horizontal axis represents the frequency domain and a vertical axis represents the base station domain. In this case, the base station domain and the subband arranged on their respective axes are based on a water filling algorithm based on the average long term channel status information (CSI).

If the long term CSI is not available, the frequency domain and the base station domain can allocate the power equally.

Preferably, a power level decided through the aforementioned two methods is transferred to the user equipment. This is because that the user equipment operated in the CoMP zone can perform channel measurement using the decided power level.

The power level can be transmitted to the user equipment through a reference signal based on a bit map and quantized power level.

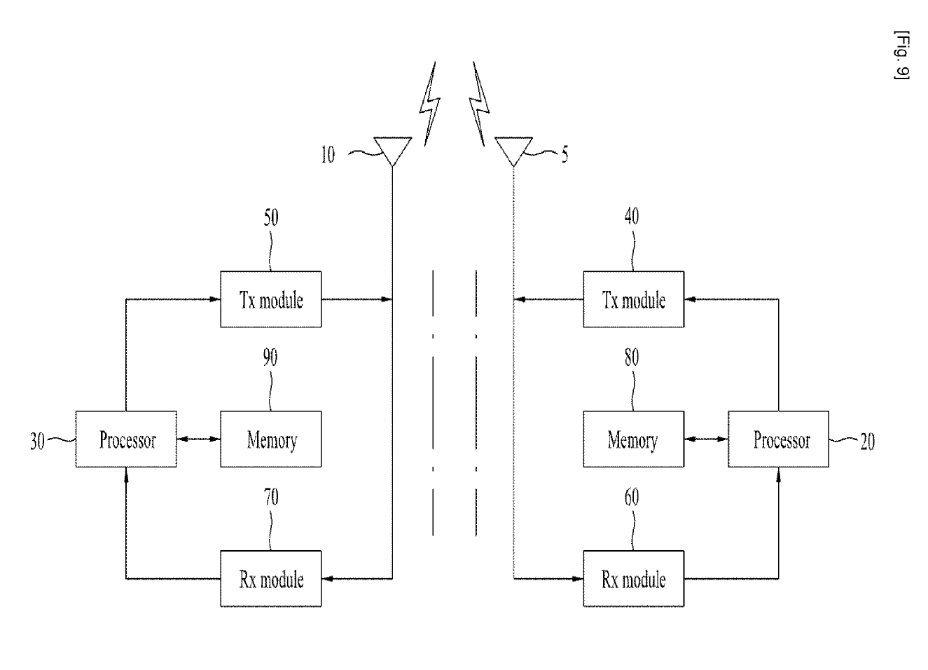

FIG. 9 is a block diagram illustrating an example of a transmitting side and a receiving side in accordance with another embodiment of the present invention.

Referring to FIG. 9, a left side illustrates a structure of the transmitting side, and a right side illustrates a structure of the receiving side. The transmitting side and the receiving side respectively include an antenna 5, 10, a processor 20, 30, a Tx module 40, 50, an Rx module 60, 70, and a memory 80, 90. The respective modules of the transmitting side perform corresponding functions of those of the receiving side.

The antenna 5, 10 serves to transmit a signal generated by the Tx module 40, 50 to the outside or receive a radio signal from the outside to transfer the radio signal to the Rx module 60, 70. If a MIMO antenna function is supported, two or more antennas may be provided.

The processor 20, 30 generally controls the whole operation of the transmitting side or the receiving side. Particularly, processor 20, 30 can perform a controller function for performing the aforementioned embodiments of the present invention, a medium access control (MAC) frame variable control function according to service characteristics and radio wave condition, a handover function, an authentication and encryption function, etc.

Particularly, the processor of the mobile station can measure the channel status with the base station and generate CQI by controlling a radio frequency (RF) module. The processor can decide whether to operate in the CoMP mode based on the CQI and control the RF module to allow its preferred subband information to be transmitted to the serving base station.

Then, the processor receives a subband of a CoMP zone that will receive data from the base station in accordance with the joint processing CoMP mode, and controls the RF module to receive same data through subbands allocated from neighboring base stations.

Also, the processor of the base station exchanges the received information with its neighboring base station if the preferred subband information of the user equipment is received from the user equipment, decides a subband to be allocated to the corresponding user equipment, and performs scheduling. If the long-term channel status information is available, the processor of the base station can decide an optimized power level through a water filling algorithm based on the long-term channel status information, and can notify the user equipment of the decided power level through the reference signal by controlling the RF module.

The Tx module 40, 50 performs predetermined coding and modulation for the data, which will be scheduled from the processor 20, 30 and then transmitted to the outside, and then transfers the coded and modulated data to the antenna 10.

The Rx module 60, 70 performs decoding and demodulation for the radio signal received from the outside through the antenna 5, 10 to recover original data and then transfer the recovered data to the processor 20, 30.

The memory 80, 90 may store a program for processing and control of the processor 20, 30, or may perform a function for temporarily storing input/output data (sleep mode information according to reference synchronization information). Also, the memory 80, 90 can include at least one type of a flash memory type, a hard disk type, a multimedia card micro type, a card type memory (for example, SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

Meanwhile, the base station can perform a controller function for performing the aforementioned embodiments of the present invention, orthogonal frequency division multiple access (OFDMA) packet scheduling, time division duplex (TDD) packet scheduling and channel multiplexing function, medium access control (MAC) frame variable control function according to service characteristics and radio wave condition, quick traffic real-time control function, handover function, authentication and encryption function, packet modulation and demodulation function for data transmission, quick packet channel coding function, and real-time modem control function through at least one of the aforementioned modules, or can further include a separate means, module or part for performing the above functions.

The method of dividing a CoMP zone into subbands in a frequency domain and al- locating the divided subbands to a user equipment in accordance with a request of the user equipment has been described as above. However, the present invention is not limited to this method, and may also be applied to a method of dividing a CoMP zone into subframes (or slots) on a time axis.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The embodiments of the present invention can be applied to various wireless access systems. Examples of various wireless access systems include 3GPP (3rd Generation Partnership Project) system, 3GPP2 system and/or IEEE 802.xx (Institute of Electrical and Electronic Engineers 802) system. The embodiments of the present invention can be applied to all technical fields to which the various access systems are applied, as well as the various access systems.

1. A method of optimizing a CoMP Zone for a joint processing mode in a user equipment of a mobile communication system, the method comprising:
transmitting information of at least one subband preferred by the user equipment among a plurality of subbands included in the CoMP zone, to a serving base station;
receiving information of a specific subband included in the CoMP zone from the serving base station; and
receiving data from at least one of the serving base station and neighboring base stations that support the CoMP, through a radio resource corresponding to the specific subband.

2. The method of claim 1, further comprising:
measuring channel quality information (CQI) of the serving base station; and
determining whether the measured channel quality information has a value less than a previously set threshold value,
wherein the step of transmitting the preferred subband information is performed if the value of the measured channel quality information is less than the previously set threshold value.

3. The method of claim 2, wherein the user equipment selects the at least one subband preferred by the user equipment by using the measured channel quality information.

4. The method of claim 1, wherein the specific subband is determined through agreement of the serving base station and the neighboring base stations.

5. The method of claim 1, further comprising:
determining a power level of the serving base station through a reference signal; and
performing channel measurement of the serving base station using the determined power level.

6. A method of optimizing a CoMP Zone for a joint processing mode in a base station of a mobile communication system, the method comprising:
receiving information of at least one subband preferred by the user equipment among a plurality of subbands included in the CoMP zone, from the user equipment;
sharing user equipment information of a CoMP mode with at least one neighboring base station that supports the CoMP zone;
performing selection and scheduling of a specific subband to be allocated to the user equipment using the user equipment information of the CoMP mode;
transmitting information of the specific subband to the user equipment; and
transmitting data to the user equipment through the specific subband, wherein the user equipment information of the CoMP mode includes at least one of the at least one subband information preferred by the user equipment, information of at least one another user equipment that receives the data through the CoMP zone, and at least one subband information preferred by at least one user equipment that desires to receive the data through the CoMP zone.

7. The method of claim 6, wherein the user equipment information of the CoMP mode further includes power allocation information of a plurality of subbands included in the CoMP zone, the method further comprising deciding an optimized power level in a frequency domain together with the neighboring base stations.

8. The method of claim 7, further comprising deciding an optimized power level in a base station domain together with the neighboring base stations.

9. The method of claim 8, wherein, if long-term channel information is provided to the base station, the step of deciding the optimized power level in each domain depends on a water filling algorithm.

10. The method of claim 8, wherein, if long-term channel information is not provided to the base station, the step of deciding the optimized power level in each domain is performed in accordance with a method of equally dividing the power level of each domain.

11. A user equipment that supports a joint processing mode for CoMP, the user equipment comprising:
a processor; and
a radio frequency (RF) module for transmitting and receiving a radio signal to and from the outside under the control of the processor;
wherein the processor transmits information of at least one subband preferred by the user equipment among a plurality of subbands included in a CoMP zone, to a serving base station by controlling the RF module, and if information of a specific subband included in the CoMP zone is received from a serving base station, receives data from at least one among the serving base station and neighboring base stations that support the CoMP zone, through a radio resource corresponding to the specific subband.

12. The user equipment of claim 11, wherein the processor measures channel quality information (CQI) of the serving base station by controlling the RF module and transmitting the information of the preferred subband to the serving base station if a value of the measured channel quality information is less than a previously set threshold value.

13. The user equipment of claim 12, wherein the processor selects the at least one preferred subband by using the measured channel quality information.

14. The user equipment of claim 11, wherein the specific subband is determined through agreement of the serving base station and the neighboring base stations.

15. The user equipment of claim 11, wherein the processor determines a power level of the serving base station through a reference signal, and performs channel measurement of the serving base station using the determined power level.
